(19) United States
(12) Patent Application Publication
(10) Pub. No.: US 2016/0377697 A1
(43) Pub. Date: Dec. 29, 2016

(54) MAPPING AND MOVEMENT TRACKING SYSTEM AND METHODS OF USING THEREOF

(71) Applicant: KYTERA TECHNOLOGIES LTD., Yokneam Illit (IL)

(72) Inventor: Assaf SELLA, Rishpon (IL)

(21) Appl. No.: 15/039,423

(22) PCT Filed: Nov. 26, 2014
(86) PCT No.: PCT/IL2014/051023

§ 371 Date: May 26, 2016

Related U.S. Application Data
(60) Provisional application No. 61/908,767, filed on Nov. 26, 2013.

(51) Int. Cl. G01S 5/02

(52) U.S. Cl. CPC G01S 5/0252; G01S 5/0294; G01S 5/0289

(57) ABSTRACT

A computerized method of mapping a plurality of anchor devices in a space. The method, providing a plurality of anchor devices which are set to be detachably deployed in a plurality of locations in a space, capturing by the plurality of anchor devices a plurality of relative distance indication messages transmitted from the plurality of anchor devices, calculating, based on each the relative distance indication message, distance indicative parameters indicative of a distance between a pair of anchor devices from the plurality of anchor devices, aggregating the distance indicative parameters, and calculating a dataset which maps a location of each one of the plurality of anchor devices in the space according to the aggregated distance indicative parameters.

### BACKGROUND

The present invention, in some embodiments thereof, relates to location based monitoring systems and methods and, more specifically, but not exclusively, to deployment, mapping and remapping of anchor devices of monitoring systems and methods.

Positioning systems are typically based on anchor devices which are mapped in locations which are known in advance. For example, in a GPS system space vehicles with known position and trajectory may be used to determine a position of an object in space. Wireless Fidelity (Wi-Fi) positioning systems are based on known locations of Wi-Fi Access Points. ZigBee™ based asset tracking applications rely on ZigBee™ anchors with known locations within the space.

The number of anchor devices that is required to determine a position is set, sometimes among others, according to the number of dimensions in which the object is tracked. For example and without limitation, in GPS systems, at least four space vehicles are required in order to position an object in a three dimensional (3D) space, and get accurate time.

Once anchor devices are mapped, various algorithms may be used in the process of tracking an object, for example: multilateration, time of Arrival (TOA), differential time of arrival (DTOA), angle of arrival (AOA), and the like. Mapping anchor devices within a space may be performed relative to a floor plan: for example, in an asset tracking application of medical equipment, the positions of the WiFi™ access points are measured relative to features such as walls and corridors of a hospital as reflected from its floor-plan. Other anchor mapping techniques include measuring anchors' absolute position using geodesic schemes embedding global navigation satellite system (GNSS) receivers in the anchors, and the like.

### SUMMARY

According to some embodiments of the present invention, there is provided a computerized method of mapping a plurality of anchor devices in a space. The computerized method comprises providing a plurality of anchor devices which are set to be detachably deployed in a plurality of locations in a space, capturing by the plurality of anchor devices a plurality of relative distance indication messages transmitted from the plurality of anchor devices, calculating, based on each relative distance indication message, distance indicative parameters indicative of a distance between a pair of anchor devices from the plurality of anchor devices, aggregating the distance indicative parameters and calculating a dataset which maps a location of each one of the plurality of anchor devices in the space according to the aggregated distance indicative parameters.

Optionally, the plurality of relative distance indication messages are transmitted over a wireless communication network that connects the plurality of anchor devices.

Optionally, the method further comprises: receiving reference location coordinates of one of the plurality of anchor devices, and setting the location of each one of the plurality of anchor devices according to the reference location coordinates.

More optionally, the reference location coordinates are received from an external mapping device.

Optionally, each anchor device is housed in a housing having an attachment element for detachably deploying the anchor device to an object within the space.

Optionally, the aggregating comprises transmitting the distance indicative parameters from each one of at least some of the plurality of anchor devices to a location computing unit.

Optionally, the calculating a dataset comprises resolving a set of relative location formulas by substituting estimated distance from the distance indicative parameters.

Optionally, the plurality of anchor devices comprise less than ten anchor devices.

Optionally, the plurality of anchor devices comprise three anchor devices which are deployed at about the same height.

Optionally, the relative distance indication messages are transmitted according to a unicast messaging protocol.

More optionally, the number of the relative distance indication messages by each anchor device is substantially similar such that energy consumption used by each anchor device is substantially similar.

Optionally, the relative distance indication messages are broadcasted messages.

Optionally, the relative distance indication messages are multicasted messages.

Optionally, the plurality of anchor devices are divided into a plurality of groups so that some of the members of the group is in an effective transmission range from each another member of the group, and wherein the calculating a dataset that comprises generating a plurality of subset datasets each of another the group and combining the plurality of subset datasets.

More optionally, the plurality of subset datasets are mapped substantially simultaneously.

Optionally, the space is a multi-storey building and the plurality of anchor devices are divided into a plurality of groups so that each group is located in another storey if a multi-storey building, and wherein the calculating a dataset that comprises generating a plurality of subset datasets each of another the group and combining the plurality of subset datasets.

Optionally, the plurality of anchor devices comprises a plurality of intermediate anchor devices that belong to more than one group of anchor devices, and enables to map the locations of anchor devices in one group relative to the locations of anchor devices of another group.

Optionally, the method further comprising receiving a plurality of signals indicative of a movement of at least one entity in the space using at least one tracking unit in at least some of the plurality of anchor devices, and wherein the tracking is performed using the dataset.

More optionally, the tracking comprising forwarding the plurality of signals to a central computing unit that performs the tracking.

More optionally, the tracking further comprising coupling a transmission unit to the at least one entity. The tracking is performed according to signals from the transmission unit which are received by the at least one tracking unit.

More optionally, the tracking further comprising coupling a receiving unit to the at least one entity. The tracking is performed according to signals received by the receiving unit from the at least one tracking unit.

Optionally, the method further comprises documenting the movement in the space and using the mapped movement to perform remapping one or more of the plurality of anchor devices.

Optionally, the method further comprises adding at least one posteriori reference location point according to the location of the at least one entity in an event triggered by the at least one entity, the at least one posteriori reference location point maps a location of an object in the space.

Optionally, the method further comprises receiving distance indicative parameters indicative of a new distance between a new anchor device and at least three of the plurality of anchor devices and updating the dataset to map the location of the new anchor device in the space according to the new distance and data from the dataset.

More optionally, the method further comprises iteratively repeating the receiving and updating in a plurality of iterations, each for another of a plurality of new anchor devices.

Optionally, the method further comprises detecting a relocation of one of the plurality of anchor devices and repeating the capturing, the calculating, the aggregating, and the calculating in response to the detection.

Optionally, the calculating a dataset comprises setting the location of each one of the plurality of anchor devices according to a physical location of one of the plurality of anchor devices.

According to some embodiments of the present invention, there is provided a system for tracking at least one of an entity and an object in a space. The system comprises a location computing unit, a plurality of anchor devices having a plurality of tracking units which are set to be detachably deployed in a plurality of locations in a space, each of at least some of the plurality of anchor devices has: a receiver for receiving a plurality of relative distance indication messages each from another of the plurality of anchor devices, a processing unit for calculating, based on each relative distance indication message, distance indicative parameters indicative of a distance to a respective of the plurality of anchor devices, and a transmitter for forwarding the distance indicative parameters to the a location computing unit, and wherein the location computing unit aggregates the distance indicative parameters and maps accordingly a location of each one of the plurality of anchor devices in a dataset of the space. The dataset is used for tracking movement of at least one entity or an object that is monitored by the plurality of tracking units.

Optionally, the system is provided as a location mapping kit that allows a non technical user to deploy the plurality of anchor devices in the space for tracking the movement.

Optionally, the location computing unit is implemented in at least one of the plurality of anchor devices.

Optionally, the plurality of anchor devices are a plurality of ZigBee™ network coordinators. The plurality of relative distance indication messages are ZigBee™ frames.

Optionally, the plurality of anchor devices are a plurality of WiFi™ access points (APs).

Optionally, the plurality of anchoring units are WiFi-direct entities and the relative distance indication messages are WiFi-direct messages.

According to some embodiments of the present invention, there is provided an anchor device of a system for tracking an entity or an object in a space. The anchor comprises a tracking unit for tracking a movement or a presence of an entity or an object in a space, a processor, a receiver which receives a plurality of relative distance indication messages from a plurality of other anchor devices, a distance indicative parameters module which calculates distance indicative parameters according to each relative distance indication message, the distance indicative parameters is indicative of a distance between the anchor device and a respective transmitting anchor device from the plurality of other anchor devices, and a transmitter which transmits the distance indicative parameters to a location computing unit.

Optionally, the anchor device further comprises a movement detection sensor for detecting relocation of the anchor device.

Optionally, the movement detection sensor is an accelerometer that detects the relocation according to a detection of a movement.

Optionally, transmitter transmits a plurality of second relative distance indication messages to at least some of the plurality of other anchor devices.

According to some embodiments of the present invention, there is provided a method for mapping a space. The method comprises receiving a plurality of outputs of a plurality of tracking units deployed in a space, documenting a plurality of movement trajectories of at least one entity in the space according to the plurality of outputs, identifying a plurality of passages in the space according to the plurality of movement trajectories, and generating a map mapping the plurality of passages.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary deployment of anchor devices in a space, according to some embodiments of the present invention;

FIG. 2 is a flowchart of a method for deploying and mapping anchor devices in a space, according to some embodiments of the present invention;

FIGS. 3A and 3B are relational views of software and hardware components of an exemplary anchor device and an exemplary location computing unit, according to some embodiments of the present invention;

FIG. 4 is a set of relative location formulas, according to some embodiments of the present invention;

FIG. 5 is a schematic illustration of an exemplary deployment of anchor devices and a monitored entity in a space, according to some embodiments of the present invention; and

FIGS. 6A-6C are graphic illustrations of monitored entity trajectories in a space, according to some embodiments of the present invention.

### DETAILED DESCRIPTION

The present invention, in some embodiments thereof, relates to location based monitoring systems and methods and, more specifically, but not exclusively, to deployment, mapping and remapping of anchor devices of monitoring systems and methods.

According to some embodiments of the present invention, there are provided methods and systems of mapping the location of a set of anchor devices in a space based on relative distance indication messages which are transmitted among the anchor devices and optionally without any external support, such as mapping devices, and/or known reference points.

According to some embodiments of the present invention, the set of anchor devices is continuously or iteratively remapped in a space during a post deployment period. This process increases the accuracy of the estimated location of the anchor devices, and optionally enables remapping the location of the anchor devices after one or more anchor devices of the set are relocated and/or removed, for example due to a malfunction, and/or after one or more new anchor devices are added to the set. Optionally, the anchor devices are mapped relative to a reference location point within the space. A reference location point may be provided as relative or absolute coordinates within the space, for example as described below.

Some embodiments of the present invention describe a kit that includes a set of anchor devices and a location computing unit for managing the deployment of the set within the space. The kit may be sold for deployment that is intended to be performed by a non technical consumer. Optionally, the anchor devices are sized to be portable, such that their position within a space may be set and/or changed by the non technical consumer.

Optionally, the anchor devices are mapped in a confined space such as room or a building, and track an entity within the confined space, for example a person or an object. Other embodiments may be used to map the anchor devices in a large space such as a multi-story building, and/or automatically reconstruct a floor-plan.

Exemplary embodiments of the present invention enable mapping anchor devices in a space without a direct communication link between all the anchor devices. In these embodiments the mapping of one or more groups of anchor devices may be iteratively expanded until all the anchor devices are mapped.

Embodiments of the present invention may be implemented using different wired and wireless communication technologies and protocols, such as but not limited to protocols that use message broadcast and/or message unicast.

Embodiments of the present invention enable a relatively simple deployment process of the anchor devices within the predefined space, thus saving on multiple installations in terms of effort and cost.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### Deployment of Anchor Devices in a Space

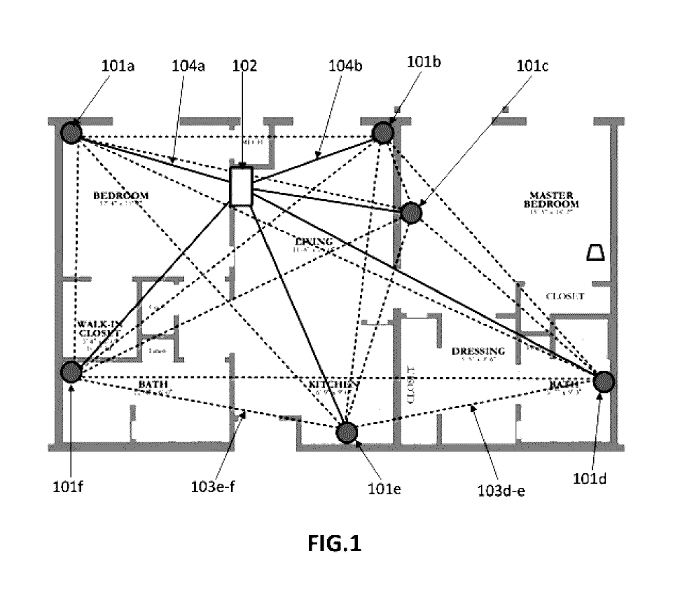

Reference is made to FIG. 1, which is a schematic illustration of an exemplary deployment of anchor devices in a space, according to some embodiments of the present invention. In the exemplary deployment depicted in FIG. 1, six anchor devices 101a, 101b, 101c, 101d, 101e and 101f are deployed within an exemplary space, which is a physically divided, for instance an apartment having several areas and rooms. The monitoring system includes a location computing unit 102 which functions as a separate entity within the space. The location computing unit, which may be logical or physical, may be implemented, as described below, as one or more separate entities and/or by one or more of the anchor devices 101a-101f. For example, the location computing unit is physically and/or logically coupled to an anchor device or deployed independently from all the anchor devices.

Each of the anchor devices 101a-101f is provided with a receiver and/or transmitter, for brevity referred to herein as a transceiver, and a processor. Some embodiments of anchor devices may be provided with different sensors such as an accelerometer, a proximity sensor, and/or the like.

Each of the anchor devices 101a-101f is provided with one or more transceivers for communicating with other anchor devices and with the location computing unit 102. The transceivers enable transmission and/or reception of messages with an origin signature, for example a unique identifier (ID) of a transmitting anchor device to other anchor devices within the space. These messages are referred to herein as relative distance indication messages. The transceivers further enable the transmission of distance indicative parameters indicative of the distances between anchor devices to the location computing unit 102. As further described below, the distance indicative parameters are calculated based on the relative distance indication messages. For brevity, the term distance indicative parameters may include an estimated distance. It should be noted that either the same or a different transceiver (either wired or wireless) may be used for communication between a certain anchor device and the location computing unit.

Exemplary communication links between anchor devices are marked by dotted lines, for example communication link 103d-e between anchor devices 101d and 101e, or communication link 103e-f between anchor devices 101e and 101f. Communication links between anchor devices 101a-101f and the location computing unit 102 are marked by solid lines, for example 104a between anchor device 101a and location computing unit 102, and 104b between anchor device 101b and location computing unit 102.

The anchor devices may be stationary or mobile. For example, if the space is an office, a stationary anchor device may be a transceiver unit embedded within or coupled to fixed locations in the office, for example in construction elements such as the floor, the ceiling, a door, a window lintel, a furniture such as a shelf, and/or the like. In another example, an anchor device is optionally housed in a housing that is designated to be hanged on a wall, attached to an object such as a furniture article, and/or placed on the floor and/or over the ceiling. The anchor devices may be provided as a do it yourself (DIY) kit for deployment that is intended to be performed by a non technical consumer.

An anchor device uses its transceiver to transmit relative distance indication messages to some or all of the other anchor devices in the set, and to transmit distance indicative parameters extracted from these messages to the logical central location computing unit, which may also be referred to herein as a central unit.

Optionally, an anchor device may be part of a portable element such as an office furniture (a sofa, a lamp, and a table), electronic equipment (a computer screen, a printer and a scanner), communication equipment (a telephone), a picture and/or any other elements hanging on a wall, and/or the like.

In use, for example during a deployment/mapping phase and/or redeployment/remapping, the anchor devices send and/or receive distance indicative messages. Each message, when processed, is indicative of a relative distance between a recipient anchor device and a transmitting anchor device within the space. For clarity, these messages are referred to herein as relative distance indication messages. The relative distance indication messages may be standard communication messages defined in the existing wireless protocols, for example as described below.

The relative distance indication messages are processed to extract distance indicative parameters, for example signal strength parameters. The distance indicative parameters may be calculated using schemes such as receive signal strength (RSS) and time of flight (TOF). In some embodiments, the distance indicative parameters are used to calculate distance to transmitting anchor devices at the receiving anchor devices. The calculated distances are then passed to the location computing unit. In some embodiments, the distance indicative parameters are passed to the location computing unit that calculates respective distances accordingly.

Optionally, the communication link between each of the anchor devices and the central location computing unit is established as a control and data link (CDL). Optionally, the CDLs are a bidirectional communication links allowing the location computing unit to use the CDLs to control the anchor devices during the mapping process, for example as discussed in detail below. Controlling the anchor devices may involve instructing when to transmit relative distance indication message(s), and optionally when to receive and/or extract distance indicative parameters indicative of the estimated relative distances from the anchor devices. The CDLs may be based on wireless communication links, wire-line communication links, and/or a combination thereof. A CDL may be based on a direct communication link between the location computing unit and each of the anchor devices, or on an indirect communication link in which networking entities (e.g. other anchor devices in the space) are used to relay information between the location computing unit and an anchor device.

In some embodiments, a ZigBee™-based CDL is used. In such embodiments, the location computing unit functions as a personal area network (PAN) Coordinator and a ZigBee™ mesh is used to relay information between anchor devices (that are ZigBee™ Routers or ZigBee™ End Devices) and to/from the PAN coordinator.

In other embodiments, anchor devices communicate via wireless local area network (WLAN) connections. For example, as exemplified below, anchor devices and the location computing unit may be implemented as Wi-Fi access-points. In such embodiments, the location computing unit may interconnect with anchor devices using a wireless distribution system (WDS), a set of wired backbone connecting the access-points, a set of standard mesh (802.11s) nodes, and/or nodes of a proprietary WLAN mesh to relay information between anchor devices.

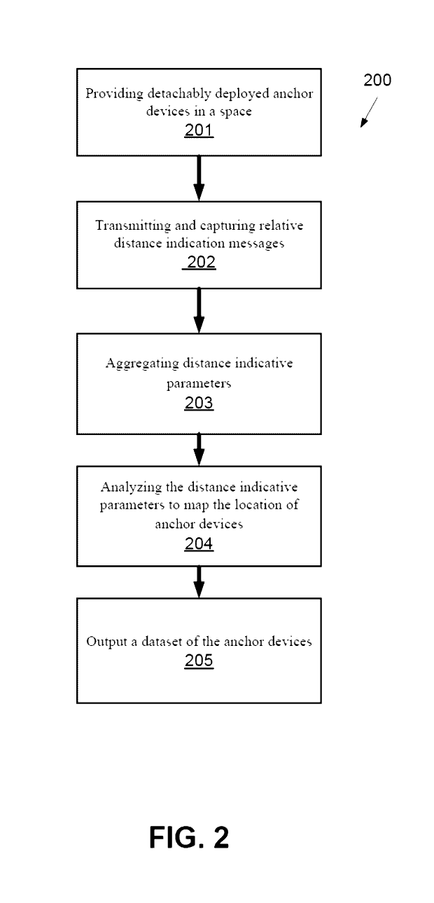

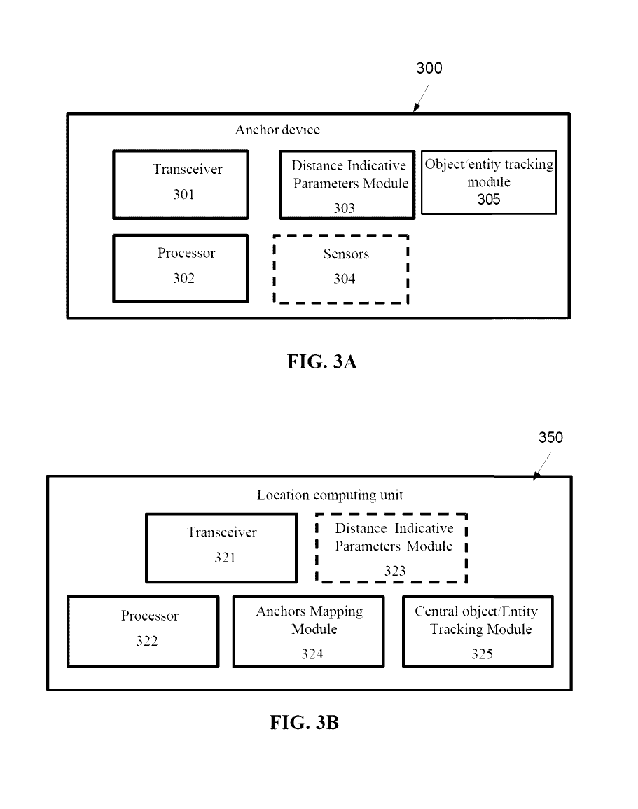

Reference is now made to FIG. 2, which is a flowchart of a method 200 for deploying and mapping of anchor devices in a space, according to some embodiments of the present invention. Reference is also made to FIGS. 3A and 3B, which is relational views of at least some of the software and hardware components of an exemplary anchor device 300 that communicates with a location computing unit 350 for mapping the location of a plurality of anchor devices in a space based on distance indicative parameters which are received from a plurality of other anchor devices and the software and hardware components of the location computing unit 350, according to some embodiments of the present invention.

The exemplary anchor device 300 includes a transceiver 301, a processor 302, a distance indicative parameters module 303 that is used to implement functions of extracting distance indicative parameters from relative distance indication messages, anchor device. Optionally, it includes sensors 304 such as passive infra-red proximity sensors that detect activity of an object in the space. The anchor device may also include an object/entity tracking module which may be a part of a tracking unit that facilitates tracking the location of an object in the space for monitoring and/or tracking one or more objects and/or entities and/or tracking devices, optionally wearable, for example as described herein. For brevity, it should be noted that computing functions described herein may be performed using the processor 302. Optionally, the sensors may include movement sensors, such as an accelerometer, that detect the potential movement of the anchor device itself. In FIG. 3B, the location computing device 350 includes a transceiver 321 for receiving distance indicative parameters from anchor devices, such as 300, optionally distance indicative parameters module 323 to process these parameters, for example as described below, a processor 322, anchors mapping module 324 for mapping the location of anchor devices 324 and optionally a central location object/tracking unit for tracking an object and/or data based on data gathered by object/entity tracking units, for example object/entity tracking units which are installed in the anchor devices, such as 300, for example as described below.

First, as shown in numeral 201, a set of anchor devices is provided. The anchor devices may be detachably deployed in the space, such that the deployment of one anchor device in the set is independent from the deployment of other anchor devices in the set. For the purpose of illustration, detachable deployment refers to different elements such as the location of each of the anchor devices in the space. In some embodiments, the communication hardware and protocols used by each of the anchor devices may not be identical for all of the anchor devices of the set.

Then, as shown in numeral 202, relative distance indication messages indicative of relative distances between anchor devices are transmitted between anchor devices so that each anchor device sends and/or receives relative distance indication messages.

Transmission of relative distance indication messages may be performed according to various methodologies, for example unicast, multicast and/or broadcast protocols. In multicast and broadcast protocols, each relative distance indication message may include a unique identification of the source anchor device. Each of the anchor devices may independently utilize one or more communication protocols, such as but not limited to Wi-Fi, ZigBee™, Bluetooth and Bluetooth Low Energy. This allows each anchor device to calculate distance indicative parameters, for example as described above.

As shown in numeral 203, distance indicative parameters from some or all of the anchor devices is aggregated in the location computing unit.

This allows, as shown in numeral 204, to process the distance indicative parameters from the anchor devices and estimate the relative distances between anchor devices. These distanced are then used to solve for the location of the anchor devices in the space. In some embodiments, consolidated extraction of relative distance data is performed by one or more anchor devices. In some embodiments the extraction of distance indicative parameters (such as RSS, or TOF) is performed by one or more anchor devices, that convey them to the location computing unit, and the extraction of relative distance data from the parameters is done by the location computing unit.

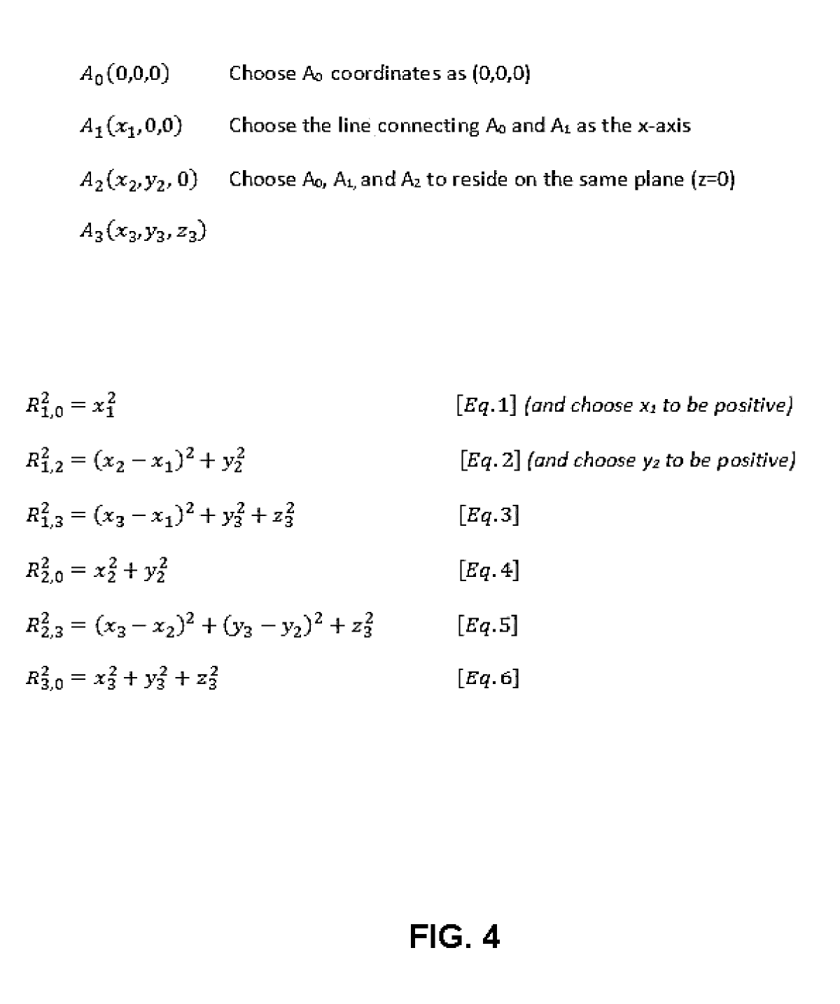

Optionally, the location computing unit maps the location of the anchor devices in the space by resolving a set of relative location formulas, as demonstrated below in FIG. 4.

Generation of exemplary relative location formulas is described herein, for brevity with the following annotations:

N denotes the number of anchor devices in a set of anchor devices;

S denotes a set of anchor devices;

A₀, A₁, . . . A_{N-1} denotes locations of anchor devices in the space S;

X, Y and Z denote the disposition of anchor devices within a three dimensional space;

the coordinates of a position of each anchor device Aᵢ deployed in the space is denoted using Cartesian coordinates by a tuple Ai (Xᵢ, Yᵢ, Zᵢ);

coordinates of a reference location point A, within the space, for example and without limitation of anchor device A₀, is denoted herein by the tuple (0,0,0); and

R_{i,j} denotes a relative distance between each two anchor devices Aᵢ, Aⱼ in S.

Ri,j may be computed for some or all of the anchor device pairs. The relative location calculation may be performed by each anchor device A, sending one or more location indication messages to other anchor devices in the set. Processing distance indicative parameters of the relative distance indication messages yields an estimate of the distance R_{i,j} between two anchor devices Ai, Aj within the set. The relative distance indication messages may be processed using schemes such as Receive Signal Strength (RSS), Time of Flight (TOF), or any other scheme which may be used to estimate distance between two objects.

In the exemplary set of relative location formulas which is depicted in FIG. 4, the number of anchor devices in the set is four (N=4), and the number of generated equations is 6 with a total of 6 parameters to be resolved and extracted. Each of the equation unknowns represents coordinates of a disposition of an anchor device within the space relative to anchor device A₀ with coordinates (0,0,0). The equations may be resolved using a wide variety of numerical analysis methods for resolving non-linear equations, such as but not limited to Newton method and Secant method, and/or by statistical methods such as Maximum Likelihood where the estimated distances R_{i,j} are provided with a reliability or confidence level metric.

In FIG. 4, relative location formulas Eq. 1, Eq. 2, Eq. 3 are formulas that relate the dispositions of anchor devices A₁, A₂, A₃ (relative to anchor device A₀) to the distances of anchor devices A₀, A₂,A₃ relative to anchor device A₁ (respectively). This is done following relative distance indication message(s) transmitted by anchor device A₁. Similarly, Eq. 4, Eq. 5, are formulas that relate the dispositions of anchor devices A₂, A₃ (relative to anchor device A₀) to the distances of anchor devices A₀, A₃ relative to anchor device A₂ (respectively) following a relative distance indication message transmitted by anchor device A₂.

When the number of anchor devices in the set is greater than four (N>4), the number of generated equations is greater than the number of anchor devices' dispositions to resolve. An additional anchor device added to a set of N anchor devices increases the number of anchor devices from N to N+1: as a result, N new equations and 3 new unknown coordinate parameters X, Y, Z to resolve are introduced. When the number of anchor devices in the set is greater than four, resolution of the set of relative location formulas is enabled, because the number of relative location formulas is greater than the overall number of unknown coordinate parameters of anchor devices Xᵢ, Yᵢ, Zᵢ. It should be noted, therefore, that reliable mapping of anchor devices within the space may be created when the number of anchor devices in the set is four or more. This method is also referred to as self-positioning scheme.

In some embodiments, anchor device Aᵢ receives a relative distance indication message sent from anchor device Aⱼ, and anchor device Aⱼ receives a relative distance indication message sent from anchor device A,. Both relative distance indication messages are indicative of the same distance R_{i,j}. When two separate relative distance indication messages indicative to distance R_{i,j} are received independently by anchor devices Aᵢ and Aⱼ, data from both relative distance indication messages may be used to improve accuracy of calculation of the distance R_{i,j}. The trade-off presented herein is between efficiency and accuracy. Analyzing more relative distance indication messages requires more computational power and transmission bandwidth; however, a more accurate estimation may be achieved when more relative distance indication messages are received and analyzed for the distance between the two anchor devices Aᵢ and Aⱼ. Alternatively or additionally, the mapping procedure may be repeated to improve the accuracy of the mapping. For example, an arbitrary anchor device A₁ may receive a location indication message sent by anchor device A₂. In such a case, R_{2,1} may be calculated as an additional estimate to R_{1,2} for the relative distance between A₁ and A₂. Each such additional estimation may be used, for example and without limitation to improve mapping and/or tracking accuracy.

In exemplary embodiments where anchor devices in the set have a fixed location in one axis, a reliable mapping may be performed using less than 4 anchor devices. In one exemplary embodiment, anchor devices are deployed in a substantially identical vertical displacement, for example at the same height such that Z₀=Z₁==Z_{N-1}. For example, the same height may be achieved by placing all the anchor devices on the ceiling of a monitored space, such as a shopping mall. In such an embodiment, a set of three anchor devices (N=3) may be mapped by solving four equations (e.g. Eq. 1, Eq. 2, and Eq. 4 in FIG. 4) according to relative distances between the 4 anchor devices.

It should be noted, as outlined above, that anchor devices may transmit relative distance indication messages according to unicast, multicast and/or broadcast protocols.

When a broadcast or a multicast protocol is used, the transmitting anchor devices enable all receiving anchor devices to calculate distance indicative parameters, the distance to the transmitting anchor devices (e.g. using RSS or TOF as described above). These distance indicative parameters are then transmitted to a central location unit that stores the unique ID of the transmitting anchor, the receiving anchors and the respective distance indicative parameters.

When using unicast messaging, the number of transmissions sent by each anchor device of a set of anchor devices deployed within a space may be substantially similar such that energy consumption used by each of the anchor devices in the set is substantially similar. Referring back to FIG. 4, in the case of N=4, each anchor device may transmit 1.5 messages on average:

A₀ may transmit for Eq. 1, and Eq. 4 (2 transmissions);

A₁ for Eq. 2, and Eq. 3 (2 transmissions);

A₂ for Eq. 5 (1 transmission); and

A₃ for Eq. 6 (1 transmission).

Upon re-mapping of anchor devices within a space, anchor devices which transmitted 2 unicast messages in a previous mapping may be configured to transmit one such message for the mapping that follows, and the other way around.

A₀ for Eq. 1;

A₁ for Eq. 2;

A₂ for Eq. 4, and Eq. 5; and

A₃ for Eq. 3, and Eq. 6.

As shown in numeral 205, a dataset of the anchor devices within the space is outputted. The dataset may be represented as coordinates in multiple dimensions, for example in three axes X, Y and Z representing horizontal and vertical disposition within the space, relative to A₀.

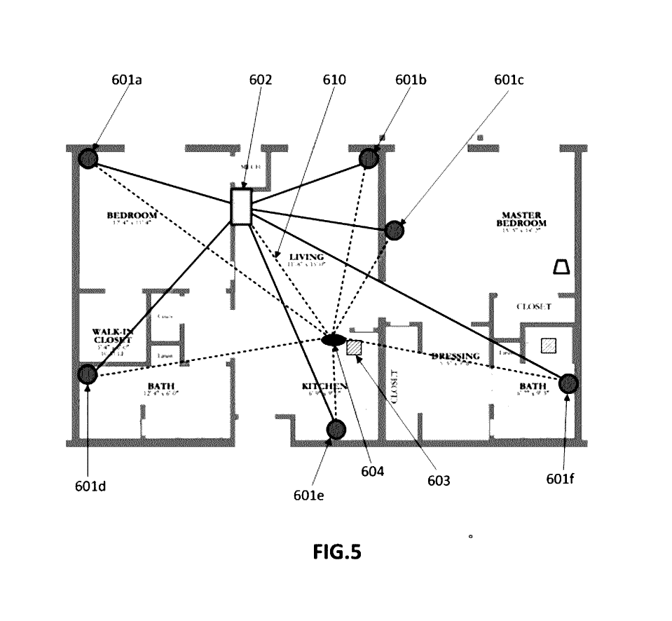

Optionally, the mapping of the anchor devices is used for finding the position or tracking the trajectories of monitored objects and/or entities in the space. For example, FIG. 5 is a schematic illustration of anchor devices which are used to monitor an entity, for example a human or an animal such as a dog, in a space, optionally after being deployed according to some embodiments of the present invention. In FIG. 5 six anchor devices 601a, 601b, 601c, 601d, 601e and 601f are deployed within an apartment, each in a different area or room within the apartment. A location computing unit 602 is shown deployed in the living room of the apartment. An exemplary reference location point 603 is shown in the kitchen of the apartment, and a monitored entity 604 is positioned next to the reference location point 603.

Additionally or alternatively, a wearable and/or an attachable user device transceiver, which is coupled to a monitored entity and/or object transmits messages that are received by some or all of the anchor devices which are deployed within the space, for example the above described relative distance indication messages. Distance indicative parameters extracted from these messages at the anchor devices are transferred to the location computing unit using the CDL, and are used by the location computing unit for calculating the location of the monitored entity and/or object relative to the anchor devices. An advantage of this scheme is that a certain transmitter may be used in the system, so the measured RSSI by the anchor devices is relative to an output power of this certain transmitter. In other words, there is no need to calibrate the output power of multiple transmitters to be of similar level. Additionally or alternatively, a wearable and/or an attachable user device transceiver, which is coupled to a monitored entity and/or object receives messages that are transmitted by some or all of the anchor devices which are deployed in the space, for example the above described relative distance indication messages. Distance indicative parameters extracted from these messages at the monitored entity are transferred to the location computing unit either directly, as shown in numeral 610, or indirectly, via one or more of the nearby anchor device(s) or network entities, and from it through the CDL to the location computing unit. The distance indicative parameters are used by the location computing unit for calculating the location of the monitored entity and/or object relative to the anchor devices. Additionally or alternatively, the user device periodically transmits relative distance indication messages to the anchor units every tracking period, for example around every second, every 5 seconds, every 10 seconds, or any intermediate or longer period. Additionally or alternatively, the anchor devices periodically transmit relative distance indication messages which are received by the user device for example around every second, every 5 seconds, every 10 seconds, or any intermediate or longer period.

Additionally or alternatively, the user device incorporates one or more movement sensors such as accelerometers to detect bodily movements such as a gesture or a posture of a user. These bodily movements data may be transmitted, for example with the relative distance indication messages, optionally whenever a user movement above a threshold is detected. By sending distance indication messages only when movement is detected, the power consumption of the user-device is reduced while maintaining continuous monitoring of the user's location.

In some embodiments of the present invention, for example during the mapping of the anchor devices, one of the anchor devices is mapped as a reference location point with arbitrary coordinates such as (0,0,0) so that the resolution of the relative location formulas yields coordinates of the anchor devices relative to the reference location point. Additionally or alternatively, the position of one or more anchor devices is known in advance and used as reference location point(s) such that the relative location formulas yield coordinates of anchor devices relative to the reference location point(s). The reference location point may be provided in a predefined location within the space such as a doorway of a room, an entry to an apartment building, or the like and/or within an object having a relatively fixed location such as a doorway, a lamp hanging from a ceiling of a room, a refrigerator in an apartment, and the like. Alternatively, an anchor device may be placed in a known disposition from a predefined location within the space.

Additionally or alternatively, the position of one or more of the anchor devices is known in advance relative to reference location point(s) with absolute coordinates which are provided by an external mapping device such as a global positioning system (GPS) module, and designated using a specific pairing of latitude and longitude, a Cartesian coordinate grid (e.g. a spherical coordinate system), an ellipsoid-based system (e.g. world geodetic system), or similar methods. For example, an exemplary reference location point is provided by a GPS coordinates in WGS84, as a point in a floor plan such as an entrance door, or the like. Additionally or alternatively, after the mapping of the anchor devices is completed and the system tracks the location of a device attached to a user (the monitored entity), the user is instructed to approach one or more objects in the space (such as a refrigerator, a bed, etc.) and tag them, for example by pressing a button on the device. Reference is made to FIG. 5 where the monitored entity 604 is adjacent to the refrigerator object 603 and can tag it. The location computing unit may calculate the position of the object(s), and set it as posteriori reference location point(s). For example, the anchor devices which are mapped arbitrarily relative to anchor device A₀, maybe mapped after the tagging relative to one or more of the posteriori reference location point(s) by shifting the (0,0,0) coordinate to one of reference location points.

Optionally, the estimated locations of the anchors are a result of a self-location scheme having degrees of freedom of 3-dimentional rotation. When using the user device for the tracking movement of the user on the same floor several sample readings of Z coordinate (height) are received. These values are about the same in the real-world (e.g. when the person wears the user device on his hand, the vertical displacement of the user device from the floor is about the same during a normal walk. The pattern of a normal walk may be detected by using the movement sensors). The use of outputs of movement sensors may eliminate the Z-degree of freedom by rotating the axis so they will be parallel to the Z-plane in the physical world. Optionally, an analysis of the axis of the Z coordinate (height) during a monitoring time is analyzed to identify relative height changes in the real world (e.g. in internet of things applications). This allows generating an alert when a person falls and the Z coordinate (height) value changes as an outcome of this fall.

Optionally, the user device is used to map the anchors, for example by using a wearable user device such as a wristband for mapping are described herein. For example, during the mapping of the anchor devices, the user, based on instructions, brings the user device to a physical proximity with some or each of the anchor devices, sequentially. When in proximity with one of the anchor devices, a data input action is selected, for example by pressing a button on the user device). The measurement data may be transmitted as distance indication messages, which are received by the anchor devices to extract distance indicative parameters for the self-positioning scheme. In such a manner, only the user device transmits the distance indication messages, and therefore there is no need to calibrate the transmit power between the multiple anchor devices.

Anchor devices may be added to a set deployed within a space, or removed from such a set. For example, an anchor device whose battery power has been exhausted may be considered, in effect, an anchor device which has been removed from a set. The anchor devices may be periodically mapped within the space such that anchor devices which have been added and/or removed from the space are reflected in the mapping. A re-mapping process may include re-solving all the relative location formulas for all the anchor devices in the set. Alternatively, each new anchor device is mapped by extracting distance indicative parameters from distance indicative messages between it and 3 or more anchor devices that were already mapped. This results a set of 3 or more relative location formulas to solve for the X, Y, Z coordinates of the new anchor device.

According to some embodiments of the present invention, one or more of the anchor devices include a movement sensor to detect self movements. The movement sensor may be an accelerometer and/or one or more push buttons. The movement sensor may detect movement events of an anchor device, namely location changes of the anchor device. For example, when the movement sensor is an accelerometer, a movement event is a change in acceleration that lasts until no change in acceleration is detected; and optionally after some additional predefined settling time. When movement events are detected, the self-positioning scheme as described above may be applied for re-mapping the anchor devices within the space.

When an anchor device detects the start and completion of its move event, it may signal the location computing unit. When the movement event is completed, the location computing unit may initiate a re-mapping of all anchor devices as described above, for example in relation to a reference point. This process may be repeated for every anchor device that detects a move event. If one or more anchor devices are moving while the re-mapping process takes place (e.g. they detected the start but not yet the completion of the move event), the location computing unit excludes these anchor devices from the remapping (e.g. ignores the distance indicative parameter they send). Optionally, the system is set to detect movements of anchor devices without using movement sensors. The system periodically re-runs the self-positioning scheme. If the resulting locations of one or more anchor devices are different than their previous locations, the relative locations between anchor devices are searched to find the smallest group of anchor which may have moved. The system assumes that the rate of changes in the location of anchor device is slow, and therefore assumes that this smallest group of anchor devices are the anchor devices who moved relative to the previous time the anchor devices were mapped. Optionally, the system is set to detect movements of anchor devices without using movement sensors. If one or more anchor devices are known to be stationary, or set to be stationary, the system periodically re-runs the self-positioning scheme relative to one of the stationary anchor devices.

Optionally, the system is set to detect movements of anchor devices without using movement sensors, as further described below and outlined above, the system can monitor one or more objects and/or entities in the space. In these embodiments, trajectories of one or more monitored objects may be logged and used, inter alia, for remapping anchor devices. In such embodiments, previously identified trajectories of anchor devices and/or monitored objects may be used as a reference for remapping a relocated anchor device.

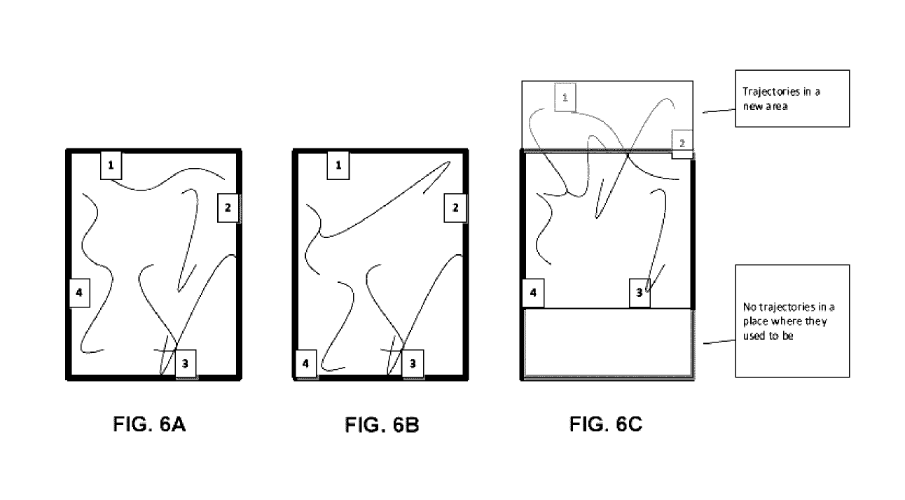

For example, reference is made to FIGS. 6A-6C which are graphic illustrations of monitored object movement trajectories in a space relative to estimated locations of a set of anchoring units in a space, according to an exemplary embodiment of the present invention. The figures demonstrate the initial location and estimated locations in an exemplary two-dimensional deployment of four anchor devices, marked as 1, 2, 3, and 4, in a rectangular space.

FIG. 6A demonstrates the initial location of the four anchor devices. Movement trajectories of a monitored entity relative to the anchor devices are shown in curved lines. In this example, the position(s) of one or more of the anchor devices deployed within the space has changed. Under a first assumption, anchor device 4 moved to the south while the positions of other anchor devices in the set remained unchanged, as shown in FIG. 6B. Alternatively, under a second assumption, the position of anchor device 4 remained unchanged and the other three anchor devices have moved to the north, as indicated by FIG. 6C.

As trajectories of monitored entities are tracked, under a first assumption that anchor device 4 has moved as shown in FIG. 6B, the recorded trajectories remain in the same area as before. This area is marked herein as a rectangular space. Under the second assumption trajectories are mapped in a new area outside the rectangular space, and there are no trajectories in areas there they used to be. For example, there are now no trajectories south of anchor device 4, who according to the assumption didn't move.

It is unlikely that the space itself has changed, and therefore, the first assumption is more probable. Accordingly, a conclusion is made that the shift in position is of anchor device 4, as shown in FIG. 6B.

According to some embodiments of the present invention, anchor devices are mapped within the space using parallel computing, for example to enable mapping of anchors in places where there is no direct communication between all anchor devices. For example, the mapping of the locations of anchor devices may be done in parallel computing threads, each from another group of communication anchor devices which separately implement a mapping process resulting in a subset mapping, for example as described with reference to FIG. 2. The grouping of anchor devices may be performed automatically according to the effective transmission range. Datasets results from multiple computing threads may be combined to create a full map (e.g. a map, a list, and/or any other location data) of anchor devices from different groups. Mapping of different groups may be coordinated based on one or more anchor devices which are mapped in different groups.

In some embodiments of the present invention, anchor devices are deployed in a space wherein some anchor devices are not in a range of communication with all other anchor devices in the set, for example in a large mall and/or a large house. In such cases, the set of anchor devices may be logically divided by the central location unit to subsets (groups) in which all or most anchor devices are able to receive and transmit location indication messages from/to all or most other anchor devices in the set, and there are enough anchor devices in the subset to solve the relative location formulas in the subset (for example, N>4 in case all anchor devices can communicate with each other). The location of an anchor device which is not part of the subset may mapped by extracting distance indicative parameters from distance indicative messages between it and 3 or more anchor devices that were already mapped. This results a set of 3 or more relative location formulas to solve for the X, Y, Z coordinates of the anchor device. This may be repeated until all anchor devices are mapped relative to the same reference point. Additionally or alternatively, subsets of relative location formulas may be solved separately for each one of the subsets of anchor devices relative to one of the anchor devices in the subsets. Once there is at least one anchor device that is common to more than one such subset, the locations of all anchor devices in the subsets can be referenced to the same reference location point.

Optionally, different subsets of anchor devices are mapped substantially in parallel. The mapping results of each of the subsets of anchor devices may then be combined together to generate a full mapping of all the anchor devices within the space relative to the same reference location point. For example, anchor devices may be deployed in each of the floors of a multi-storey building. Mapping of anchor devices within each floor of the building may be performed separately relative to a reference location point in the floor (e.g., one of the anchor devices in the floor). If in one place there is a wireless communication link between one anchor device that was mapped in one floor, and three or more anchor devices that were mapped in an adjacent floor (e.g., anchor devices in area of the stairway connecting the floors), then this anchor device can be mapped relative to the reference location point of the adjacent floor, as described in the one of the embodiments above, and subsequently all anchor devices can be mapped relative to the same reference location point. Hence, mapping of anchor devices of each floor are combined together to generate a complete mapping of anchor devices within the entire building relative to the same reference location point. Heuristics may be applied to perform mapping of anchor devices in the different floors serially, one floor after another, or in parallel. To decrease overall mapping time, the anchor devices in each of the floors may be mapped substantially in parallel, and the results may be combined together only after anchor devices in all the floors have been mapped.

An exemplary deployment may be in a space such as a multi-floor building, where different subsets of anchor devices are deployed in different floors of the building, and transmission of relative distance indication messages between anchor devices is not enabled through the floors. A subset of relative location formulas that corresponds with the subset of anchor devices in a certain floor is resolved for mapping the location of anchor devices within that floor. Optionally, an intermediate anchor device is placed between floors to acquire relative distance indicative messages from subsets of anchor devices deployed in two adjacent floors. This is enabled, for example and without limitation, in stairways between floors. Such anchor device transfers the relative distance parameters to a location computing unit for mapping the subset of anchor devices in one floor in relation to the reference location point of the subset of anchor devices in the adjacent floor.

For example, when each of the relative distance indication messages is provided for three dimensions in three axes X, Y, and Z, at least four (N≧4) anchor devices are to be deployed in each of the floors to generate sets of relative location formulas. Each of the relative distances R_{i,j} within the formulas represents relative distance between two anchor devices Aᵢ and Aⱼ deployed within a floor. In other examples where one dimension such as Z is fixed, similar schemes may be applied by using anchor device sets in which the number of anchor devices is larger than 3 (N≧3).

According to some embodiments of the present invention, the locations of some anchor devices are iteratively mapped based on an existing map of other anchor devices. In such a manner, a group of anchor devices which can send distance indicative messages to one another are mapped, for example as described above with reference to FIG. 2. Then, optionally iteratively, anchor devices which are deployed in proximity to some of the anchor devices in the group, for example in an area wherein not all anchor devices are in a range of communication with others, and are added sequentially. For example, the estimated disposition calculated for anchor devices in the subset is used for calculating an estimated distance from an additional, unmapped anchor device. This may be performed in a sequential manner. Each mapped anchor device is added to the subset that includes the anchoring units which are used for mapping. In such a manner, the space in which anchor devices are mapped sequentially increases.

According to some embodiments of the present invention, existing protocols are used for communication between anchor devices and/or between anchor devices and a location computing unit. In some embodiments of the present invention, anchor devices are set as ZigBee™ network routers, and/or ZigBee™ simple nodes, and the location computing unit is set as ZigBee network coordinator. Each node may use broadcast or unicast communication frames for messages, for example the above described messages. The anchor devices may be synchronized to a ZigBee™ Beacon, and periodically send or receive relative distance indication messages. In some exemplary embodiments, ZigBee™ based anchor devices are deployed in a house, and the monitored entity is a person that wears a bracelet with an embedded ZigBee™ transceiver. Once the anchor devices are mapped, the location of the person is continuously monitored using ZigBee™ received signal strength measurements. In some embodiments, anchor devices communicate by sending messages which are encoded according to WiFi™ wireless communication protocol, for example IEEE 802.11. Each anchor device is optionally set as a WiFi™ access point (AP) that communicates with other anchor device (e.g. WiFi™ AP) via WiFi™ channels. For example, each anchor device periodically transmits a sequence of relative distance indication messages as probe-request messages in each of the channels used by the network (for example, in Wi-Fi™, channels 1, 6, and 11). If RSS schemes are used to assess relative distances between source and destination anchor devices, the transmission power of each AP may be predefined and registered in advance in the location computing unit. Probe-request frames may be used to receive information regarding the RSS and media access control (MAC) address of the transmitting AP. As such, they may send a CTS2Self message containing a variable for duration which is equal to the expected time in which they are absent from the communication channel. Alternatively, WiFi™-Direct mechanisms such as a notice of absence may be used. Optionally, the anchor devices are defined WiFi™ stations (STAs) associated with an AP. To measure the relative distance, each such WiFi™ station sends broadcast or unicast messages to other stations (e.g. anchor devices) in the network which use a promiscuous mode to receive relevant data and convey the data to a central location computing unit. Additionally and alternatively, the anchor devices may be WiFi-direct entities such as group owners and devices, which use WiFi-direct scan with probe requests and probe responses as relative distance indication messages for measuring relative distances between source and destination access points.

As described above, the dataset of the locations of the anchor devices may be used for tracking movements of monitored objects and/or entities in a monitored space. In some embodiments of the present invention, the movements of the monitored objects and/or the entities are used to construct a floor plan of the monitored space, optionally without a-priori data regarding the positions of the anchor devices within the space. The construction of the floor plan may be performed by drawing an outline of the space, for example and without limitation drawing a contour of a space that includes the anchor devices. The space may be represented in a distinctive color such as black.

Movement trajectories of monitored objects in the space are tracked by tracking units which are of the anchor devices and examined. As used herein, a tracking unit covers one or more hardware module(s) used for monitoring the presence and/or movement of one or more monitored entities and/or objects, for example an infrared sensor, an image sensor, a signal receiver for receiving a location signal from transmission unit that is attached to the monitored entity(ies), a signal transmitter for transmitting a location signal to a receiving unit that is attached to the monitored entity(ies) and/or the like. The tracking unit is optionally a node in a mesh of tracking units that are used to monitor the location and/or moment of the monitored entity. In such embodiments, the tracking units may forward the location data to a central unit that maps and/or analyzes the presence and/or movement of the monitored entity in relation to the location of the anchor units. The forwarding may be done using the transmitter of the anchor device. Coordinates of movement trajectories are extracted and marked in a visualization of the space, for example in another distinctive color. As more and more movement trajectories are tracked, the visualization of the space is updated so that the areas in which movement trajectories are detected are marked as open for passage, for example colored in white and other areas are marked as closed for passage, for example colored in black. The visualization may now be processed to reflect a floor plan of the space (e.g., it includes the perimeter of the building, the inside walls, and the major items in the space like furniture, etc.).

Additionally or alternatively, movement parameters such as velocity, acceleration and/or the rate of changes in the vertical displacement of a monitored entity and/or object may be used to map or refine a floor-plan. As described above, entities may be monitored using a wearable device, such as a bracelet. These wearable devices can be used to detect vertical displacements such as standing up from a chair or a sofa, walking velocity and/or acceleration. These parameters may be aggregated and analyzed to identify seating areas, bed(s), door(s), walls and/or the like. For example, a seating area is identified at a location where the person wearing the bracelet de-accelerates, and the vertical displacement goes down (indicative of a person getting to sit).

The constructed floor plan may be refined according to image processing algorithms using parameters typical to a monitored environment. For example, a typical width of the wall in a house may be used to refine a floor plan where walls separate two areas in which movement trajectories are tracked, but no trajectories are tracked which crossed the two areas.

Additionally and alternatively, the scheme described herein may be used to update dynamically the floor-plan as locations of key elements within the space change, for example a location of a sofa within a room. As described above, in some exemplary embodiments, the location of entities is monitored by tracking the location of a wearable device, for example a wearable transceiver, for example an embedded ZigBee™ transceiver. Once the anchor devices are mapped, the location of a person is continuously monitored using the wearable transceiver. Optionally, the person marks a key element in the house, for example a refrigerator or a closet, by locating the wearable device in proximity to the key element and initiating a key element calibration process, for example by pressing on a button embedded within the bracelet. Pressing on the button sends an indication that tags the key element, for example in a floor plan.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems and methods will be developed and the scope of the terms anchor devices, location computing unit, and relative distance indication messages is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computerized method of mapping a plurality of anchor devices in a space, comprising:
providing a plurality of anchor devices which are set to be detachably deployed in a plurality of locations in a space and function as nodes of a wireless mesh network;
capturing by said plurality of anchor devices a plurality of relative distance indication messages transmitted from the location of said plurality of anchor devices;
calculating, based on each said relative distance indication message, distance indicative parameters indicative of a distance between a pair of anchor devices from said plurality of anchor devices, said distance indicative parameters are relayed between said plurality of anchor devices over said wireless mesh;
aggregating said distance indicative parameters Which are relayed over said wireless me sh; and
calculating a dataset which maps a location of each one of said plurality of anchor devices in said space according to said aggregated distance indicative parameters.

2. (canceled)

3. The method of claim 1, further comprising:
receiving reference location coordinates of one of said plurality of anchor devices; and
setting said location of each one of said plurality of anchor devices according to said reference location coordinates.

4. The method of claim 3, wherein said reference location coordinates are received from an external mapping device.

5. The method of claim 1, wherein each said anchor device is housed in a housing having an attachment element for detachably deploying said anchor device to an object within said space.

6. The method of claim 1, wherein said aggregating comprises transmitting said distance indicative parameters from each one of at least some of said plurality of anchor devices to a location computing unit.

7-13. (canceled)

14. The method of claim 1, wherein said plurality of anchor devices are divided into a plurality of groups so that some of the members of said group is in an effective transmission range from each another member of said group; and wherein said calculating a dataset that comprises generating a plurality of subset datasets each of another said group and combining said plurality of subset datasets.

15. (canceled)

16. The method of claim 1, wherein said space is a multi-storey building and said plurality of anchor devices are divided into a plurality of groups so that each said group is located in another storey if a multi-storey building; and wherein said calculating a dataset that comprises generating a plurality of subset datasets each of another said group and combining said plurality of subset datasets.

17. The method of claim 1, wherein said plurality of anchor devices comprises a plurality of intermediate anchor devices that belong to more than one group of anchor devices, and enables to map the locations of anchor devices in one group relative to the locations of anchor devices of another group.

18. The method of claim 1, further comprising:
receiving a plurality of signals indicative of a movement of at least one entity in said space using at least one tracking unit in at least some of said plurality of anchor devices; and
wherein said tracking is performed using said dataset.

19-22. (canceled)

23. The method of claim 18, further comprising adding at least one posteriori reference location point according to the location of said at least one entity in an event triggered by said at least one entity, said at least one posteriori reference location point maps a location of an object in said space.

24. The method of claim 1, further comprising receiving distance indicative parameters indicative of a new distance between a new anchor device and at least three of said plurality of anchor devices and updating said dataset to map the location of said new anchor device in said space according to said new distance and data from said dataset.

25. (canceled)

26. The method of claim 1, further comprising detecting a relocation of one of said plurality of anchor devices and repeating said capturing, said calculating, said aggregating, and said calculating in response to said detection.

27. The method of claim 1, wherein said calculating a dataset comprises setting said location of each one of said plurality of anchor devices according to a physical location of one of said plurality of anchor devices.

28. The method of claim 1, wherein said plurality of relative distance indication messages are transmitted from a user device sequentially located in proximity to each of said plurality of anchor devices.

29. A system for tracking at least one of an entity and an object in a space, comprising:
a location computing unit;
a plurality of anchor devices each having a tracking unit and set to be detachably deployed in one of a plurality of locations in a space, said plurality of anchor devices are nodes of a wireless mesh network;
each of at least some of said plurality of anchor devices has:
a receiver for receiving a plurality of relative distance indication messages each from a location of at least on of: another of said plurality of anchor devices, at least one tracked entity and an tracked object;
a processing unit for calculating, based on said relative distance indication messages, distance indicative parameters indicative of a distance between said at least one tracked entity or said tracked object and each of said plurality of anchor devices;
a transmitter for relaying said distance indicative parameters to said a location computing unit over to said mesh;
wherein said location computing unit aggregates said distance indicative parameters and maps accordingly a location of each one of said plurality of anchor devices in a dataset of said space; and
wherein said dataset is used for tracking movement of at least one entity or an object that is monitored by said plurality of tracking units.

30. The system of claim 29, wherein a triggering message transmitted by at least one wearable tracking unit of said at least one entity based on an analysis of bodily movement.

31. The system of claim 29, wherein said system is provided as a location mapping kit that allows a non technical user to deploy said plurality of anchor devices in said space for tracking said movement.

32. (canceled)

33. The system of claim 29, wherein said plurality of anchor devices are a plurality of ZigBee™ network routers, and the location computing unit is a ZigBee™ network coordinator;
wherein said plurality of relative distance indication messages are ZigBee™ frames.

34-36. (canceled)

37. The system of claim 29, further comprising a movement detection sensor for detecting relocation of said anchor device.

38-39. (canceled)

40. A method for mapping a space, comprising:
receiving a plurality of outputs of a plurality of tracking units deployed in a space;
documenting a plurality of movement trajectories of at least one entity in said space according to said plurality of outputs;
identifying a plurality of passages in said space according to said plurality of movement trajectories; and
generating a map mapping said plurality of passages.
